(19) United States
(12) Patent Application Publication
(10) Pub. No.: US 2026/0229025 A1
(43) Pub. Date: Aug. 6, 2026

(54) SELECTIVE NEURAL DECOMPRESSION

(71) Applicant: Flawless Holdings Limited, London (GB)

(72) Inventor: Hyeongwoo KIM, London (GB)

(21) Appl. No.: 19/632,605

(22) Filed: Mar. 30, 2026

Related U.S. Application Data
(63) Continuation of application No. PCT/GB2024/052513, filed on Sep. 30, 2024.
(60) Provisional application No. 63/586,601, filed on Sep. 29, 2023.

(51) Int. Cl. G06V 10/82; G06V 10/25

(52) U.S. Cl. CPC G06V 10/82; G06V 10/25

(57) ABSTRACT

A computer-implemented method includes receiving input video data having a first resolution, obtaining region of interest (ROI) data indicating a spatiotemporal ROI within the input video data, and generating output video data using the input video data and the ROI data. Generating the output data includes selectively increasing, using a machine-learned model, a resolution of a portion of the input video data within the spatiotemporal ROI from the first resolution to a second resolution.

### CROSS-REFERENCE TO RELATED APPLICATIONS

This application is a continuation International Application No. PCT/GB2024/052513, filed Sep. 30, 2024, which claims the benefit of U.S. Provisional Application No. 63/586,601, filed Sep. 29, 2023, under 35 U.S.C. § 119(a). Each of the above-referenced patent applications is incorporated by reference in its entirety.

### BACKGROUND OF THE INVENTION

### Field of the Invention

The present disclosure relates to video transmission and playback. The disclosure has particular, but not exclusive, relevance to video streaming.

### Description of the Related Technology

Video streaming, including on-demand video streaming and live video streaming, has become the most popular way to consume media such as television, movies, and sports. Video streaming is bandwidth intensive due to the need to transmit large volumes of video data over a network at a sufficient rate to provide a seamless viewing experience. Video codecs, which provide algorithms to compress video data prior to transmission and to subsequently decompress the video data for playback, are therefore an active area of research due to the need to minimize contributions of video streaming to network traffic.

Certain video codecs make use of neural networks and artificial intelligence (AI) for encoding and decoding video data. For example, AI-based Video Codec (AIVC) proposed in the article AIVC: Artificial Intelligence based Video Codec, Ladune and Philippe, 2022, arXiv: 2202.04365, uses pretrained conditional autoencoders to determine an appropriate mode of compression by a neural encoder at the sender side, to enable a given image frame to be reconstructed by a neural decoder at the receiver side. Other examples are based on the use of a neural decoder trained as a generative adversarial network (GAN) as described in the article Generative Adversarial Networks, Goodfellow et al, 2014, arXiv: 1406.2661.

AI-based video codecs typically require significant computing resources at the receiver side, which can render them inappropriate for video streaming and/or where the receiver has limited processing power.

### SUMMARY

According to aspects of the present disclosure, there are provided a computer-implemented method, one or more non-transient storage media carrying instructions for carrying out the method, and a system comprising at least one processor and at least one memory storing instructions which, when executed by the at least one processor, cause the at least one processor to carry out the method.

The method includes receiving input video data having a first resolution, obtaining region of interest (ROI) data indicating a spatiotemporal ROI within the input video data, and generating output video data using the input video data and the ROI data. Generating the output data includes selectively increasing, using a machine-learned model, a resolution of a portion of the input video data within the spatiotemporal ROI from the first resolution to a second resolution.

By selectively increasing the resolution of the portion of the video data within the spatiotemporal region of interest, selected parts of the video content can be rendered at a relatively high resolution compared to the received input video data. This may enable the input video data to be transmitted at a relatively low resolution, and therefore lower bit rate, whilst enabling a high fidelity to be recovered in the spatiotemporal region of interest, thereby mitigating detrimental effects to the viewing experience. The ability to increase the resolution of certain portions of the video data may be enabled by the machine-learned model having been pretrained on certain types of objects (such as human bodies, human faces, or text), which may result in improved performance compared with known super-resolution methods that attempt to increase the resolution of an entire scene irrespective of its content.

The first and second resolutions may be temporal resolutions (such as frame rates or frequencies), spatial resolutions (such as image frame size), or color resolutions (such as color depths). Further, any combination of these resolutions may be selectively increased to generate the output video data. For example, by selectively increasing the temporal resolution of the input video data within the spatiotemporal ROI, video content for which it may be important to represent motion at a high fidelity, such as fast-moving objects or moving human faces, may be rendered at a relatively high frequency compared with other video content such as background regions. Similarly, by selectively increasing the color resolution of input video data within the spatiotemporal ROI, parts of a scene with high degrees of color variation may be rendered at a higher color depth than other parts of the scene.

The input video data may be received from a remote system, and obtaining the ROI data may include receiving the ROI data from the remote system. In this way, the processing required to identify the spatiotemporal ROI may be performed at the sender side, where the limits on computational resources and/or time may be less stringent than at the receiver side. In some examples, the input video data may be downsampled prior to transmission, in which case the sender-side processing may take place on the input video data prior to or after the downsampling.

In other examples, obtaining the ROI data may include processing the input video data to generate the ROI data. In this way, ROI data is not required to be transmitted with the input video data, which may result in more efficient bandwidth use, particularly in cases where the ROI data may be high-dimensional, such as attention data generated by a vision transformer.

The method may include selectively processing said portion of the input video data using the machine-learned model to generate intermediate video data having the second resolution, and generating the output video data using the input video data and the intermediate video data. Selectively processing the portion of the input video data may result in relatively modest computational requirements (e.g. compute and/or memory) at the receiver side, compared with more comprehensive processing of the input video data. This may be valuable if the receiver has limited processing power such as in the case of a mobile device and/or if the input video data needs to be processed quickly for display, such as in the case of video streaming. The output video data may for example depict certain video content not depicted in the spatiotemporal ROI at the first resolution. Such parts may therefore be spared from processing by the machine-learned model or any other model or algorithm, reducing the demand on computational resources at the receiver device.

Selectively processing said portion of the input video data may include processing a plurality of patches of the input video data, each patch comprising a respective portion of a respective image frame of the input video data. In some cases, patches from different image frames may be processed together, for example using a vision transformer, enabling spatial relationships and temporal relationships may be learned within a single framework. In this way, the method is provided with flexibility to increase resolution in spatial, temporal, and/or color dimensions, as well as improving the temporal stability of the intermediate video data.

The method may include processing the input video data using a vision transformer to generate attention data, and obtaining the ROI data may include identifying the spatiotemporal ROI using the attention data. The generated attention data may automatically identify spatiotemporal regions of the input video data that are pertinent to a particular task such as super-resolution or object detection, which may also correspond to regions for which resolution/fidelity is particularly noticeable to a viewer. The machine-learned model used to increase the resolution of the portion of the input video data may also include the vision transformer, in which case the machine learning model may be trained in an end-to-end fashion to generate the attention data and the output video data. In other examples, the machine-learned model may be a separate model from the vision transformer.

In examples, the ROI data is first ROI data, the portion of the video data is a first portion of the video data, and the machine-learned model is a first machine-learned model. The method may then include obtaining second ROI data indicating a second spatiotemporal ROI within the input video data. Generating output video data may further include using a second machine-learned model to selectively increase a resolution of a second portion of the input video data within the second spatiotemporal ROI from the first resolution to a third resolution. The third resolution may be the same or different from the second resolution. The first and second machine-learned models may for example be trained to process video data depicting different classes of object (such as human faces and text), or different types of scene (such as indoor and outdoor), or having any other different property, such as different lighting levels or different visual styles. Having multiple models trained on different classes of object may improve the capability of the method to faithfully reproduce high-resolution video data whilst also reducing the training burden and enabling the machine-learned models to be relatively compact, resource-efficient, and effective. The first and second machine-learned models may share components, such as having one or more neural network layers in common with one another, which may result in improved space efficiency at the receiver side.

The machine-learned model may have been trained using steps including obtaining first training video data depicting video content at the first resolution and second training video data comprising a first portion depicting a first part of the video content at the first resolution and a second portion depicting a second part of the video content at the second resolution, processing the first training video data using the model to generate a candidate reconstruction of the second training video data, and updating the model based at least in part on a comparison between the second training video data and the candidate reconstruction of the second training video data. In this way, the machine-learned model may learn to selectively increase the resolution of relevant objects or video content only, whilst leaving other portions of video data unaffected. This may facilitate the output of the machine-learned model blending seamlessly with surrounding portions of the input video data.

In examples where the machine-learned model is arranged to process the spatiotemporal ROI data, the training of the machine-learned model may further include obtaining training ROI data indicating a spatio-temporal region of the first training video data, and generating the candidate reconstruction of the second training video data further comprises processing the training ROI data. The training ROI data may for example indicate the second portion of the training video data, enabling the model to learn to selectively increase the resolution of regions indicated in ROI data. Alternatively, the machine-learned model may include an ROI detector, obtaining the training ROI data may include processing the first training video data using the ROI detector to generate the training ROI data, and the updating of the model may include updating the ROI detector. In this way, the machine-learned model may be trained to generate ROI data and output video data in an end-to-end manner. The machine-learned model may include a vision transformer, and the ROI detector comprises one or more attention blocks or attention layers of the vision transformer.

Obtaining the second video data may include obtaining source video data depicting the video content at the second resolution, and selectively downsampling a portion of the source video data depicting the first part of the video content. The first training video data may optionally also be obtained by downsampling the source video data. This method enables large training datasets to be generated from high-resolution video data. The downsampled portion of the source video data may be determined in a manual or automated manner, for example using an object detector to identify a region of the source video data corresponding to objects of a given class and then downsampling portions of the source video data distinct from this identified region. In other examples, source video data may be provided at a third resolution, and different portions of the source video data may be selectively downsampled to the first and second resolutions to generate the second video data. In further examples still, the second video data may be obtained by selectively increasing the resolution of source data, for example using a pre-trained super-resolution network.

According to further aspects of the present disclosure, there is provided a computer-implemented method of training a machine learning model using the steps described above, along with one or more non-transient storage media carrying instructions for carrying out the training method, and a system comprising at least one processor and at least one memory storing instructions which, when executed by the at least one processor, cause the at least one processor to carry out the training method.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 schematically shows a first example of a system for conveying video data in accordance with the present disclosure.

FIG. 2 schematically shows a second example of a system for conveying video data in accordance with the present disclosure.

FIG. 3 is a flow diagram representing a method of conveying video data in accordance with the invention.

FIG. 4 illustrates a first example of a method of selectively decompressing video data.

FIG. 5 illustrates a second example of a method of selectively decompressing video data.

FIG. 6 illustrates a third example of a method of selectively decompressing video data.

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Embodiments of the present disclosure relate to the transmission and playback of video data. In particular, embodiments described herein address issues related to processing and memory demands of video decompression, for example in the context of live video streaming and on-demand video streaming and/or when performed using a device with relatively modest processing or memory capabilities, such as a mobile device or a smart television.

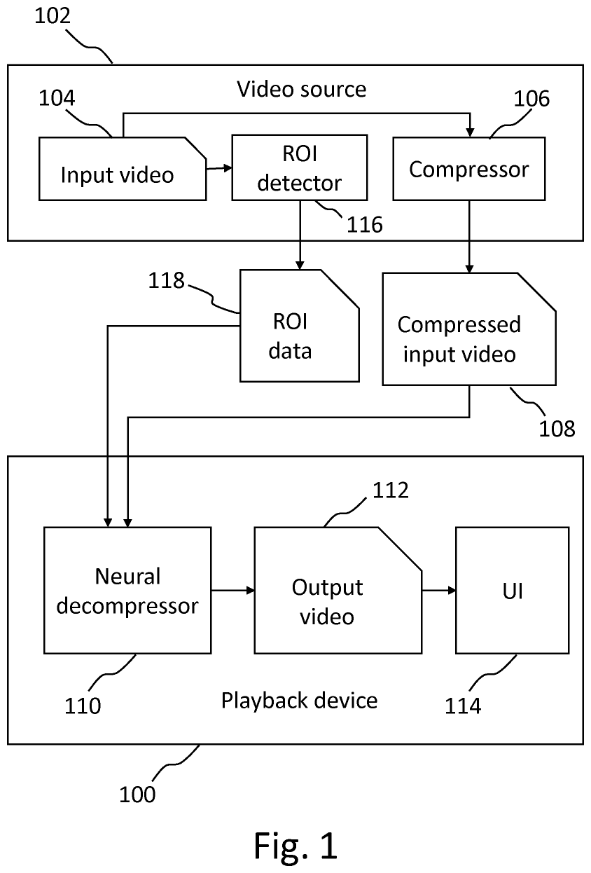

FIG. 1 shows an example of a system including a playback device 100 for use by one or more users to view video content. The playback device 100 may for example be a desktop computer, a laptop computer, a tablet computer, a smartphone, a smart television, a virtual reality headset, an augmented reality headset, a mixed reality headset, an integrated computer of a vehicle or other system, or any other electronic device capable of presenting video data on a display. In the present disclosure, video data refers to sequences of digital image frames to be presented sequentially on one or more displays. Video content, by contrast, refers to the semantic content depicted within video data. For example, a given portion of video content may include a given scene, such as a scene of a movie or part of a sports event. This video content may be depicted in video data in various different formats, for example at different resolutions and/or at different frame rates. Video data may optionally be accompanied by audio data, for example providing a soundtrack corresponding to the video content depicted within the video data.

In the present example, the playback device 100 is arranged to play back video content depicted in video data received from a video source 102. The video source 102 may include one or more devices or systems arranged to generate or receive input video data 104. The input video data 104 may for example depict live action and/or animated video content. In some examples, the input video data 104 may include video content generated using one or more machine-learned models, for example as described in U.S. Pat. Nos. 11,398,255 and 11,562,597, the entirety of which are incorporated by reference for all purposes.

The input video data 104 may be compressed using a compressor 106 to generate compressed input video data 108. The compressed input video data 108 may have a lower spatial resolution and/or a lower temporal resolution and/or a lower color resolution than the input video data 104. Within the meaning of the present disclosure, temporal resolution may correspond to frame rate, spatial resolution may correspond to image frame size, and color resolution may correspond to color depth. The compressed input video data 108 may thus depict the same video content as the input video data 104 but at a lower data size. The compressed input video data 108 may be transmitted to the playback device 100 over a network such as the internet. The compressed input video data 108 may be encoded using any suitable video codec for transmission. In examples where the playback device 100 is a mobile device, the network may include a core network and an access network such as a radio access network. Alternatively, the playback device 100 may interface with the network via any suitable wired or wireless networking technology, such as Wi-Fi.

The generating of the compressed input video data 108 may be performed asynchronously and in advance of transmission, for example at the time when the input video data 104 is first provided to the video source 102. In other examples, such as in the case of live streaming of a sports event or music event, the input video data 104 may not be available until transmission is about to take place, in which case the generating of the compressed input video data 108 may be carried out upon receipt of the input video data 104 and just prior to transmission of the compressed input video data 108. In some examples, the compressing of the input video data 104 may be carried out in response to a determination that a connection between the video source 102 and the playback device 100 has insufficient bandwidth to transmit the uncompressed input video data 104. As such, different portions of the input video data 104 may be transmitted at different resolutions depending on a varying available bandwidth.

The compressed input video data 108 is selectively decompressed using a neural decompressor 110 to generate output video data 112. The compressed input video data 108 may be decoded using a video codec using prior to decompression. Broadly speaking, the neural decompressor 110 selectively increases the resolution of certain portions of the compressed video data 108. The neural decompressor includes one or more trained neural networks, which are examples of machine-learned models. Operation of the neural decompressor 110 is described in more detail below.

The output video data 112 may be presented to a viewer via a user interface 114 of the playback device 100. The user interface 114 may include one or more displays. For example, the compressed input video data 108 may be selectively decompressed and presented to the viewer in substantially real-time (for example, with a short delay) as the compressed input video data 108 is received at the playback device 100, thereby enabling streaming of video content from the video source 102. As will be explained in more detail hereinafter, the output video data 112 may depict different parts of the video content at different resolutions. For example, some spatiotemporal regions of the output video data may depict video content at the same spatial, temporal and color resolution as the compressed input video data 108. Other spatiotemporal regions of the output video data 112 may depict video content at a higher spatial, temporal, and/or color resolution than the compressed input video data 108, such as the spatial, temporal, and/or color resolution of the input video data 104.

In the present example, to facilitate the selective decompression of the compressed input video data 108, the input video data 104 is processed using a region of interest (ROI) detector 116 to generate ROI data 118. As will be explained in more detail hereinafter, the ROI data 118 may be used by the neural decompressor 110 to identify or determine which parts of the compressed input video data 108 are to be selectively decompressed. The ROI data 118 may be transmitted to the playback device 100, either together with, or separately from, the compressed input video data 108. In some examples, the ROI data 118 may be generated by a separate system or device to the compressed video data 208.

The ROI data 118 may indicate spatiotemporal ROIs within the input video data 104. For the purpose of the present disclosure, a spatiotemporal ROI defines a portion of video data containing video content to be selectively decompressed. The portion of video data within a spatiotemporal ROI may span multiple image frames and may include at least part of each of those image frames. The location, dimensions and/or shape of the spatiotemporal ROI may vary between frames, for example to track an object such as a human face appearing within the video content. The ROI data 118 may for example include framewise coordinates and dimensions of a bounding box corresponding to the spatiotemporal ROI. The coordinates may for example be pixel coordinates. The ROI data 118 may include such information for each frame of a sequence of frames or may include such information for only a subset of a sequence of frames, such as once every 5 frames or once every 10 frames. The framewise location and dimensions of the ROI for the intervening frames may then be determined by interpolation or curve fitting. In other examples, the ROI data 118 may indicate offsets from an initial location and initial dimensions of the ROI. In this way, ROI data 118 my only need to be provided when the ROI moves or changes dimensions relative to the image frames.

The ROI detector 116 may include any suitable algorithm(s) and/or model(s) for determining a spatiotemporal ROI. For example, the ROI detector 116 may include a video object detector or object tracker to identify and locate objects of one or more given classes for which selective decompression is to be applied. Classes of objects corresponding to spatiotemporal ROIs may include, for example, human or animal faces, human or animal bodies, vehicles, text content, or any other suitable class depending on the type of video content depicted in the input video data 104.

The ROI detector 116 may for example include one or more neural network models and/or other machine learning models. Suitable models include models based on vision transformers, such as Video Sparse Transformer with Attention-Guided Memory (VSTAM), TransVOD, and Progressive Temporal-Spatial Enhanced TransFormer Towards Video Object Detection (PTSEFormer). A vision transformer is a neural network model that includes a self-attention mechanism which can be trained to identify relationships between image frames or image patches (e.g., fixed-dimension portions of image frames), for example across a sequence of image frames. In the context of object detection within a given image frame, the self-attention mechanism can leverage information from nearby image frames to improve detection accuracy and temporally stabilize object detection outputs. Other examples of suitable models include You Only Look Once Video (YOLOV), Diversity-Aware Feature Aggregation for Attention-Based Video Object Detection (DAFA-F). Still further, video object detection models may be based on an OmniMotion representation of a scene, as discussed in the article Tracking Everything Everywhere All at Once, Q. Wang et al, 2023, arXiv: 2306.05422, the entirety of which is incorporated by reference for all purposes. Any of the above models may be trained using labelled training datasets that may be selected in dependence on the particular object classes and video content of interest. Labelled datasets for training such models on a range of object classes are publicly available, including for example BDD100K, Detecting Biological Locomotion in Video (BOLD), Something-something-v2, Youtube-BoundingBoxes, and Video Person-Clustering Dataset (VPCD). In some examples, machine learning models may be trained on relatively large general-purpose datasets and then fine-tuned on task-specific datasets such as datasets containing video data resembling the input video data 104 in terms of style and/or semantic content. In further examples still, the ROI detector 116 may include a semantic segmentation model capable of identifying sets of pixels corresponding to a spatiotemporal ROI.

In the example of FIG. 1, the ROI detector 116 is shown as processing uncompressed input video data 104, which may be beneficial for accurately detecting spatiotemporal ROIs. However, in other examples, the ROI detector 116 may process a lower resolution version of the input video data 104, such as compressed input video data 108, which may reduce the computational cost of detecting the spatiotemporal ROIs. The ROI data 118 may be generated before, after, or in parallel with the generating of the compressed input video data 108, and similarly may be generated in advance of transmission of the compressed input video data 108, or concurrently with the transmission of the compressed input video data 108. In further examples still, the compression step may be omitted altogether, and the methods described herein may be used to selectively increase the spatial and/or temporal resolution of input data obtained by a video source and transmitted to a playback device.

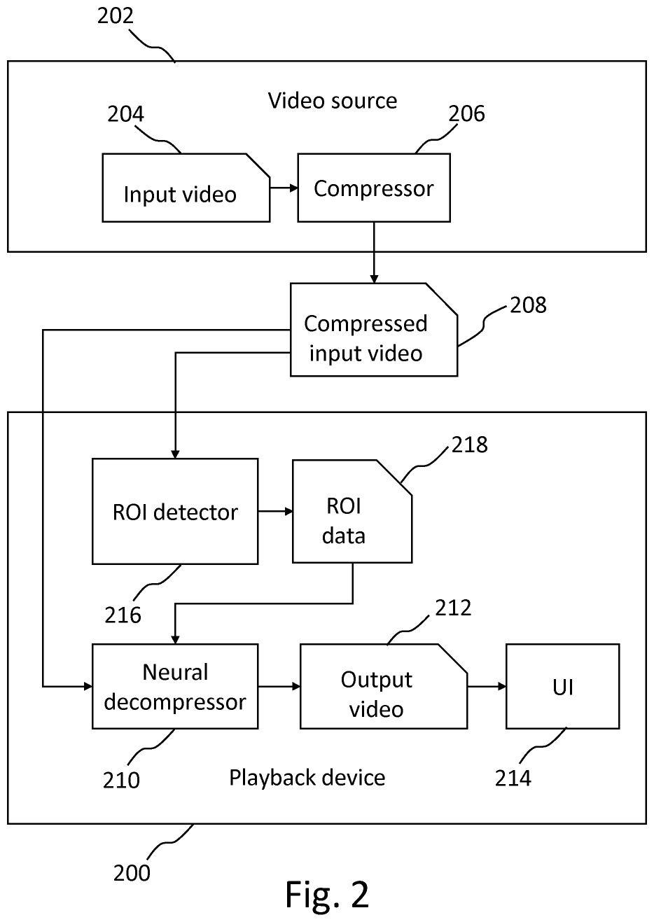

FIG. 2 shows a second example of a system for carrying out methods according to the present disclosure. The functional components shown in FIG. 2 substantially correspond to the functional components in FIG. 1 having the same reference numerals (mod 100). However, unlike in FIG. 1, the ROI detector 216 of FIG. 2 is part of the playback device. As a result, the ROI data 218 does not need to be transmitted from the video source 202 to the playback device 200. In some examples, the ROI detector 216 and the neural decompressor 210 may be combined, for example being implemented as a single machine learning model such as a vision transformer. Such a model may identify and then selectively process regions of interest to generate the output video data 212. For example, a vision transformer may generate attention data indicating relationships or correspondences between image patches across a sequence of image frames. This attention data may be used to identify a spatiotemporal ROI, for example by indicating a set of image patches that are semantically linked across a sequence of image frames or a set of image patches containing a particular class of object. The indicated set of image patches may then correspond to the spatiotemporal ROI or may be used to determine the spatiotemporal ROI. The set of image patches may then be selectively processed to increase the resolution of the portion of the video data contained within the image patches. The resulting processed set of image patches may include image patches with a higher spatial resolution or color resolution, and/or may include a greater number of image patches corresponding to a higher temporal resolution. To facilitate this, the vision transformer may generate a spatiotemporal positional embedding for each image patch in the set, and may generate additional image patches with spatiotemporal positional embeddings corresponding to new image frames between those of the compressed input video data. In this way, the selective decompressing by the neural decompressor 210 may be recast as a sequence-to-sequence mapping problem, to which transformer-based architectures are well-suited.

The configuration of the system of FIG. 2 may be particularly advantageous for settings where bandwidth is tightly limited but computational resources at the playback device 200 are plentiful. By contrast, the configuration of the system of FIG. 1 may be suitable where computational resources at the playback device 100 are limited, and/or when it is important for playback to take place shortly after the receiving of the compressed input video data 108.

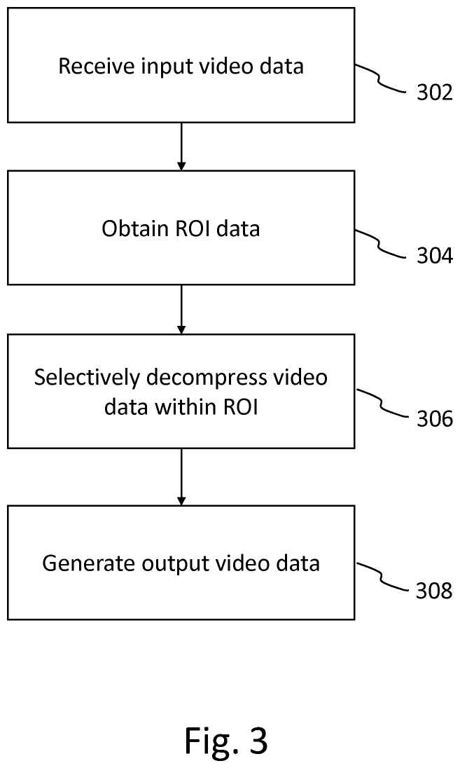

FIG. 3 shows an example of a method performed at a device such as the playback device 100 of FIG. 1 or the playback device 200 of FIG. 2. The method proceeds with receiving, at 302, input video data from a remote video source. The input video data may optionally have been compressed prior to transmission from the remote video source. The method continues with obtaining, at 304, ROI data indicating one or more spatiotemporal regions of interest. The ROI data may be received from a remote source such as the remote video source. In other examples, the ROI data may be generated locally at the device. The method continues with selectively decompressing, at 306, a portion of the input video data within the spatiotemporal ROI. The method concludes with generating, at 308, output video data.

In some implementations, the selective decompressing off the input video data may result in intermediate video data which has a higher spatial and/or temporal and/or color resolution than the input video data. In order for the corresponding output video data to be displayable by a display device, the output video data may have a video format corresponding to the higher resolution, even if parts of the output video data have an actual resolution corresponding to the lower resolution (for example by upsampling, duplicating pixels and/or repeated image frames as explained below).

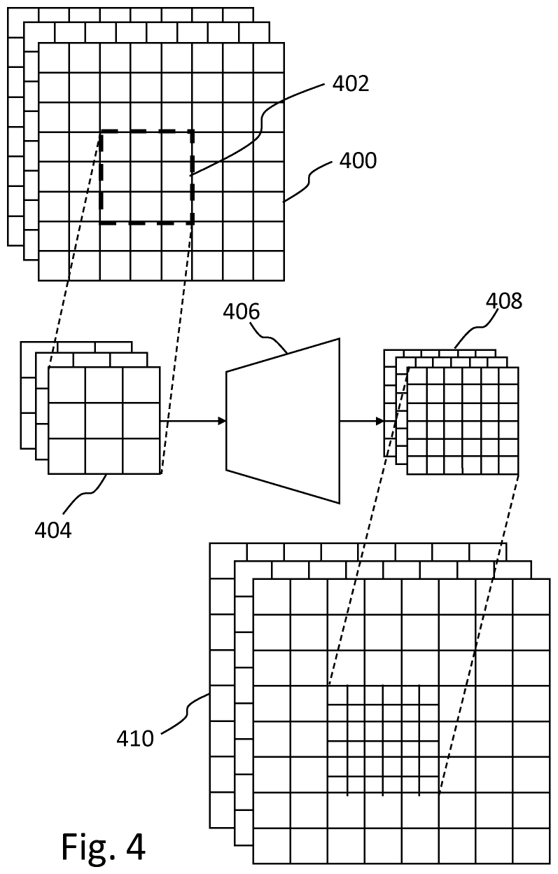

FIG. 4 shows an example in which the methods disclosed herein are used to selectively increase the spatial resolution of video data. In this example, input video data 400 comprises a sequence of image frames having a first spatial resolution (for example, corresponding to a first pixel density or a first pixel size). ROI data is obtained indicating a spatiotemporal ROI 402 within the input video data 400. The spatiotemporal ROI 402 may for example indicate a location of an object of interest such as a human face across multiple image frames. A portion 404 of the input video data 400 falling within the spatiotemporal ROI 402 is selectively decompressed using a super-resolution network 406. The super-resolution network 406 may be any suitable form of neural network for increasing the spatial resolution of video data. The super-resolution may include a sequence of one or more successive neural network layers or components with progressively higher resolution outputs.

The super-resolution network 406 may be configured to process a single input image frames or multiple input image frames to generate one or more output image frames, for example using a sliding window approach. The super-resolution network may be arranged to receive image frame portions of fixed size or variable size. In the cases of a fixed image size, multiple super-resolution networks may be provided, with different input sizes to handle different sized ROIs. The different super-resolution networks may optionally share network layers or components. For example, a super-resolution network with a smaller input size may differ from a super-resolution network with a larger input size only by the inclusion of additional preceding network layers. A super-resolution network arranged to handle variable input sizes (corresponding to differing sizes of ROI) may for example be implemented as a fully convolutional or deconvolutional neural network. In one example, the super-resolution network 406 may be based on at least part of a vision transformer model arranged to process image patches from the input video data 400. The vision transformer may be capable of taking sequences of image patches of varying lengths, for example corresponding to different sizes and or durations of ROI. Image patches may be represented by grid squares in the various image frames. It will be appreciated that, using the vision transformer approach, the image patches output by the super-resolution network 406 may correspond to smaller portions of image content than image patches input to the super-resolution network 406.

In this example of FIG. 4, the super-resolution network 406 generates intermediate video data 408 depicting the same video content as the portion 404 but at a higher spatial resolution. Output video data 410 is generated by replacing the portion 404 in the input video data 400 with the intermediate video data 404. Since the image frames of the intermediate video data 408 have a higher pixel density than the image frames of the input video data 400, it may be necessary to increase the pixel density or size of the image frames of the input video data 400 to enable them to be combined with the image frames of the intermediate video data 408. This may be achieved for example using bilinear or bicubic interpolation, neighbor interpolation, Lanczos resampling or any other suitable upsampling method, such as duplicating pixels when the upsampling factor is a power of two.

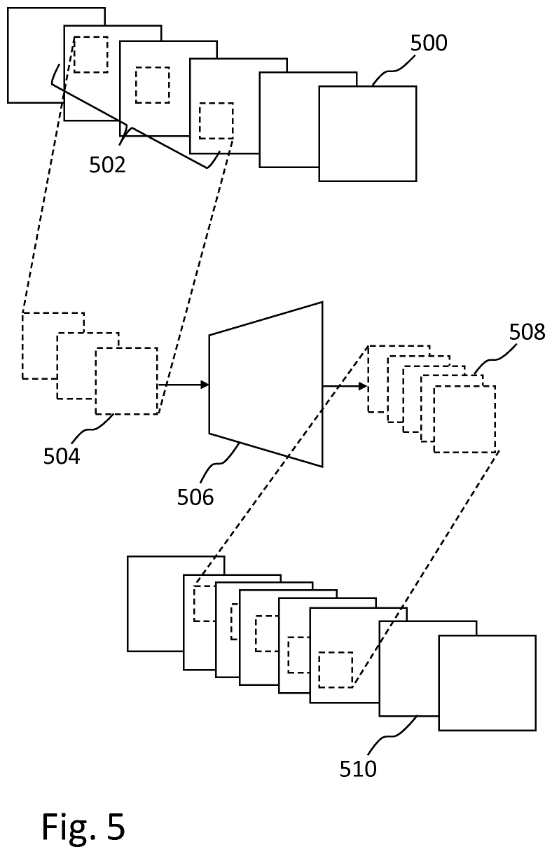

FIG. 5 shows an example in which the methods disclosed herein are used to selectively increase the temporal resolution of video data. In this example, input video data 500 comprises a sequence of image frames having a first temporal resolution (for example, corresponding to a first frame rate or a first frequency). ROI data is obtained indicating a spatiotemporal ROI 502 within the input video data 500. The spatiotemporal ROI 502 may for example indicate a location of an object of interest or a highly dynamic portion of video content. In this example, the spatiotemporal ROI 502 corresponds to respective portions of a sequence of image frames. In this example, it is observed that the location of the respective portions varies between the sequence of image frames, for example as an object of interest moves within the video content. In other examples, the size and/or shape of a spatiotemporal ROI may additionally, or alternatively, vary between image frames. A portion 504 of the input video data 500 falling within the spatiotemporal ROI 502 is selectively decompressed using a temporal super-resolution network 506. The temporal super-resolution network 506 may be arranged to process a first sequence of image frame portions to generate a second sequence of image frame portions, the second sequence having a large number of image frame portions than the first sequence. The temporal super-resolution network may for example be a convolutional neural network arranged to take as input a space-time volume of image frame portions having a first frame depth and generate as outputs a space-time volume of image frame portions having a second frame depth. The temporal super-resolution network may for example have an encoder-decoder structure. Alternatively, the temporal super-resolution network may be based on a vision transformer architecture and be arranged to perform sequence-to-sequence mapping of a first set of image patches to a second set of image patches, where the second set includes a greater number of image patches than the first set. In contrast with simple interpolation or upsampling, the temporal super-resolution network 506 may be capable of capturing dynamic effects such as motion blur as well as faithfully reproducing the fidelity of movement within the video content. Further implementations are possible for the super-resolution network, for example an implicit model such as described in the article Instant Neural Graphics Primitives with a Multiresolution Hash Encoding, by Müller et al, 2022, arXiv: 2201.05989, which develops ideas from the article NeRF: Representing Scenes as Neural Radiance Fields for View Synthesis, by Mildenhall et al, 2020, arXiv: 2003.08934. Both articles are incorporated by reference in their entirety for all purposes.

In this example of FIG. 5, the temporal super-resolution network 506 generates intermediate video data 508 depicting the same video content as the portion 504 but at a higher temporal resolution, i.e., with a greater number of image frame portions. Output video data 510 is generated by replacing the portion 504 in the input video data 500 with the intermediate video data 504. Since the intermediate video data 508 has a temporal resolution than the input video data 500, it may be necessary to increase the temporal resolution of the input video data 500 to enable it to be combined with the intermediate video data 508, which may be achieved using a suitable temporal upsampling method such as interpolation or repeating image frames if the upsampling factor is a power of two.

In further examples, the methods described herein may be used to selectively increase both the spatial resolution and the temporal resolution of video data. In this regard, the temporal super-resolution network 506 of FIG. 5 may be replaced with a spatiotemporal super-resolution network. The spatiotemporal super-resolution network may also be implemented using any suitable network architecture. For example, an encoder-decoder network may be arranged to increase both the spatial and temporal resolution of a sequence of image frame portions. Alternatively, the portion of input video data falling within the spatiotemporal ROI may comprise a set of image patches from across multiple image frames of the input video data. The spatiotemporal super-resolution network may then perform a sequence-to-sequence mapping to generate a larger set of image patches corresponding to a higher spatial resolution and a higher temporal resolution. In further examples still, a super-resolution network may additionally or alternatively be arranged to selectively increase the color resolution of portions of video data. In summary, the super-resolution network may be used to increase any combination of spatial, temporal, and/or color resolution.

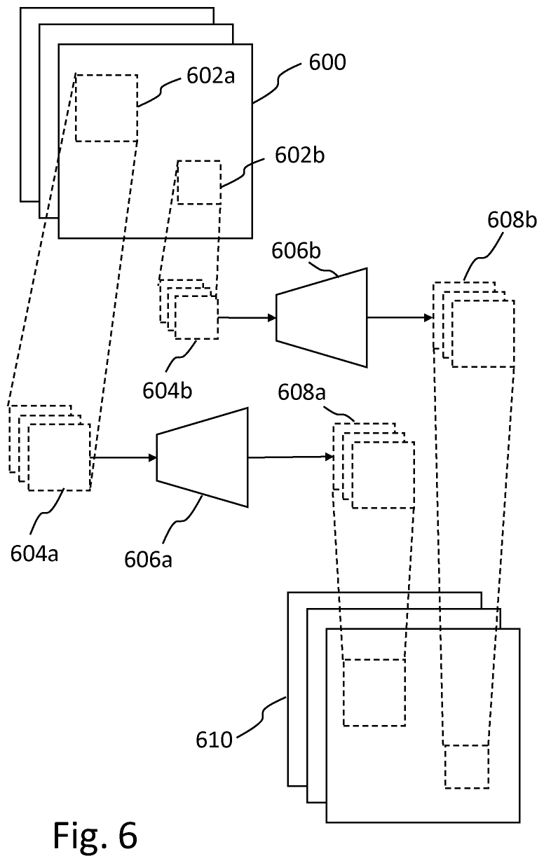

FIG. 6 shows an example in which two separate super-resolution networks are used to selectively increase the spatial resolution of two separate portions of video data. In this example, input video data 600 comprises a sequence of image frames having a first spatial resolution. In this example, ROI data is obtained indicating a first spatiotemporal ROI 602a and a second spatiotemporal ROI 602b. The different spatiotemporal regions of interest may be distinct or partially overlapping in the spatial and/or temporal dimension. The different spatiotemporal regions of interest may for example depict objects of different classes, or different objects of a common class. A portion 604a of the input video data 600 falling within the first spatiotemporal ROI 602a is selectively decompressed using a first super-resolution network 606a. A portion 604b of the input video data 600 falling within the second spatiotemporal ROI 602b is selectively decompressed using a second super-resolution network 606b. In particular, the first super-resolution network 606a generates first intermediate video data and the second super-resolution network generates second intermediate video data 606b. Output video data 610 is generated from the first intermediate video data 608a, the second intermediate video data 608b, and the input video data 600.

In the example of FIG. 6, both super-resolution networks are spatial super-resolution networks, whereas in other examples a combination of spatial, temporal, spatiotemporal, and color super-resolution networks may operate on different portions of video data. The first super-resolution network 606a may differ from the second super-resolution network 606b, for example due to having a different architecture and/or having been trained on different datasets. For example, one super-resolution network may have been trained on datasets depicting human faces, whereas the other super-resolution network may have been trained on datasets depicting text content. In some examples, this factor may be adjustable for example by executing different number of network layers, and a neural decompressor such as the neural decompressors 110, 210 may be arranged determine a common factor to be applied in cases where multiple spatiotemporal ROIs are indicted in a common set of image frames, to facilitate combining the resulting portions of intermediate video data with the input video data.

The methods described herein may involve combining portions of input video data with portions of video data that have been processed using a super-resolution network or other machine-learned model. It is possible that this may result in artefacts in which edge effects or boundary effects are visible, which may have a detrimental effect on viewing experience. In order to mitigate this undesirable consequence, the super-resolution network may be trained to only increase the spatial resolution of portions of video data fully contained within the spatiotemporal ROI, leaving portions of video data at the edge of the spatiotemporal ROI unaltered. In this way, the processed and unprocessed portions of video data can be placed together contiguously or overlaid on one another without causing edge effects. To achieve this, the spatiotemporal ROI may be deliberately determined to be at least slightly larger than the size of the relevant object or video content.

During training, the super-resolution network or machine-learned model may be trained to increase the resolution of the relevant object or video content, whilst leaving the surrounding regions visually unaffected. To achieve this, first training video data may be obtained depicting video content at a first resolution, and second training video data may be obtained having a first portion depicting a first part of the video content at the first resolution and a second portion depicting a second part of the video content at a second resolution, the second resolution being higher than the first resolution. The first training video data and the second training video data may for example be obtained by downsampling source video data depicting the video content at the second resolution.

Having obtained the first training video data and the second training video data, the super-resolution network may be trained to process the first training video data to generate a candidate reconstruction of the second training video data (in which the first part of the video content appears at the first resolution and the second part of the video content appears at the second resolution). The super-resolution network may be updated based at least in part on a comparison between the second training video data and the first candidate reconstruction of the second training video data.

In some examples, the super-resolution network may be adversarially trained to reconstruct the second training video data from the first training video data. In this case, a discriminator network may be arranged to take as input the candidate reconstruction of the second training video data and to predict whether it has received the candidate reconstruction or the ground truth second training video data. The discriminator network may take further inputs, for example the first training video data, which may simplify the task of the discriminator network, thereby improving the efficiency of training the super-resolution network. One or more adversarial losses may be determined which reward the discriminator network for making correct predictions and reward the super-resolution network for causing the discriminator to make incorrect predictions.

Backpropagation may be used to determine a gradient of the adversarial loss with respect to parameters of the super-resolution network and the discriminator network, and the parameter values of super-resolution network and the discriminator network may be updated in dependence on the determined gradient of the adversarial loss, for example using gradient descent or a variant thereof. The adversarial loss may be supplemented with one or more further losses, such as a photometric loss which penalizes differences between pixel values of the (ground truth) second training video data and the candidate reconstruction of the second training video data, and/or a perceptual loss which penalizes differences between network-derived features of the (ground truth) second training video data and the candidate reconstruction of the second training video data. The photometric loss may for example be an L1 loss, an L2 loss, or any other suitable loss based on a comparison between pixel values. In a particular example, the photometric loss may be a modified L2 loss which is modified to reduce a contribution of small photometric differences.

By combining an adversarial loss function with a photometric and/or perceptual loss function, the super-resolution network can learn to generate reconstructions which are both photometrically alike to the ground truth and stylistically/visually indistinguishable from the ground truth.

In implementations where the super-resolution network or machine-learned model is arranged to process ROI data alongside input video data (for example attention data or segmentation data indicating relevant video content), the training may further involve obtaining training ROI data to provide to the model alongside the first training video data. The training ROI data may indicate the second portion of the training video data, enabling the super-resolution network to learn to selectively increase the resolution of regions indicated in ROI data. Alternatively, the machine-learned model may include an ROI detector, obtaining the training ROI data may include processing the first training video data using the ROI detector to generate the training ROI data, and the updating of the model may include updating the ROI detector. In this way, the machine-learned model may be trained to generate ROI data and output video data in an end-to-end manner. In examples where adversarial training is performed as discussed above, the training ROI data may optionally be provided as a further input to the discriminator network.

It will be appreciated that the training methods described above are intended only as examples and other training methods may be used, depending on the exact nature of the machine-learned model. Alternative or additional methods of mitigating edge effects or boundary effects may also be deployed, such as alpha matting, boundary feathering or boundary fusion, for example as described in the article Background Matting: The World is Your Green Screen, Sengupta et al, 2020, arXiv: 2004.00626, the entirety of which is incorporated by reference for all purposes. Such methods may make use of attention data or segmentation data already computed at the ROI detection stage.

At least some aspects of the examples described herein with reference to FIGS. 1-6 comprise computer processes or methods performed in one or more processing systems and/or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example a hard disk; optical memory devices in general; etc.

The above embodiments are to be understood as illustrative examples of the invention. Further embodiments of the invention are envisaged. For example, the methods described herein could be used for selective super-resolution of individual images, rather than video data. Furthermore, the methods may be used in contexts other than video transmission, for example to enable more compact storage of image or video content or to improve the quality of video data obtained at a low resolution. Further still, analogous methods to those described herein could be applied to other media data such as audio data, in which case a temporal ROI may be identified and selectively increased in resolution. This may enable an audio track to be transmitted at a relatively low bandwidth whilst retaining the fidelity of sections or parts of more complex or otherwise important parts of the audio track, thereby avoiding a noticeable detrimental impact on a user's listening experience. Such methods for video data and audio data may be performed in parallel in the case of video data with an associated audio track. In this case, common temporal ROI data may optionally be used between the video and audio tracks. As a further comment, although in FIGS. 4-6 the spatiotemporal ROIs are depicted as squares or rectangles in each image frame, in other examples the spatiotemporal ROIs may have different shape, for example determined by attention data generated during the ROI detection stage.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A system comprising at least one processor and at least one memory holding instructions which, when executed by the at least one processor, cause the at least one processor to carry out operations comprising:
receiving input video data having a first resolution;
obtaining region of interest (ROI) data indicating a spatiotemporal ROI within the input video data; and
generating output video data using the input video data and the ROI data,
wherein the generating comprises selectively increasing, using a machine-learned model, a resolution of a portion of the input video data within the spatiotemporal ROI from the first resolution to a second resolution.

2. The system of claim 1, wherein the first resolution is a first spatial resolution, and the second resolution is a second spatial resolution.

3. The system of claim 1, wherein the first resolution is a first temporal resolution, and the second resolution is a second temporal resolution.

4. The system of claim 1, wherein the first resolution is a first color resolution, and the second resolution is a second color resolution.

5. The system of claim 1, wherein:
the input video data is received from a remote system; and
obtaining the ROI data comprises receiving the ROI data from the remote system.

6. The system of claim 1, wherein obtaining the ROI data comprises processing the input video data.

7. The system of claim 1, wherein generating the output video data comprises:
selectively processing said portion of the input video data using the machine-learned model to generate intermediate video data having the second resolution; and
generating the output video data using the input video data and the intermediate video data.

8. The system of claim 7, wherein selectively processing said portion of the input video data comprises processing a plurality of patches of the input video data, each patch comprising a respective portion of a respective image frame of the input video data.

9. The system of claim 1, wherein:
the operations comprise processing the input video data using a vision transformer to generate attention data; and
obtaining the ROI data comprises identifying the spatiotemporal ROI using the attention data.

10. The system of claim 1, wherein the machine learning model comprises the vision transformer.

11. The system of claim 1, wherein:
the ROI data is first ROI data indicating a first spatiotemporal ROI;
the portion of the input video data is a first portion of the video data;
the machine-learned model is a first machine-learned model;
the operations further comprise obtaining second ROI data indicating a second spatiotemporal ROI within the input video data; and
generating output video data further comprises selectively increasing, using a second machine-learned model, a resolution of a second portion of the input video data within the second spatiotemporal ROI from the first resolution to the second resolution.

12. The system of claim 11, wherein the first spatiotemporal ROI corresponds to an instance of an object of a first class and the second spatiotemporal ROI corresponds to an instance of an object of a second class which is different from the first class.

13. The system of claim 11, wherein the first machine-learned model and the second machine-learned model have one or more neural network layers in common with one another.

14. The system of claim 1, wherein the spatiotemporal ROI corresponds to respective portions of a plurality of image frames in the input video data.

15. The system of claim 1, wherein the machine-learned model has been trained using steps including:
obtaining first training video data depicting video content at the first resolution and second training video data comprising a first portion depicting a first part of the video content at the first resolution and a second portion depicting a second part of the video content at the second resolution;
processing the first training video data using the machine-learned model to generate a candidate reconstruction of the second training video data; and
updating the machine-learned model based at least in part on a comparison between the second training video data and the candidate reconstruction of the second training video data.

16. The system of claim 15, wherein:
the training of the machine-learned model further comprises obtaining training ROI data indicating a spatio-temporal region of the first training video data, ; and
generating the candidate reconstruction of the second training video data further comprises processing the training ROI data.

17. The system of claim 16, wherein:
the machine-learned model comprises an ROI detector;
obtaining the training ROI data comprises processing the first training video data using the ROI detector to generate the training ROI data; and
the updating of the machine-learned model comprises updating the ROI detector.

18. The system of claim 16, wherein the machine-learned model comprises a vision transformer and the ROI detector comprises one or more attention blocks of the vision transformer.

19. A computer-implemented method comprising:
receiving input video data having a first resolution;
obtaining ROI data indicating a spatiotemporal ROI within the input video data; and
generating output video data using the input video data and the ROI data,
wherein the generating comprises selectively increasing, using a machine-learned model, a resolution of a portion of the input video data within the spatiotemporal ROI from the first resolution to a second resolution.

20. One or more non-transitory storage media comprising instructions which, when executed by the at least one processor, cause the at least one processor to carry out operations comprising:
receiving input video data having a first resolution;
obtaining ROI data indicating a spatiotemporal ROI within the input video data; and
generating output video data using the input video data and the ROI data,
wherein the generating comprises selectively increasing, using a machine-learned model, a resolution of a portion of the input video data within the spatiotemporal ROI from the first resolution to a second resolution.
